(19) United States
(12) Patent Application Publication
(10) Pub. No.: US 2021/0217116 A1
(43) Pub. Date: Jul. 15, 2021

(54) SYSTEM AND/OR METHOD FOR DIGITAL AUTHENTICATION AND AUDITING OF REAL-WORLD EVENT/ACTIVITY PARTICIPATION

(71) Applicant: NOVA SOUTHEASTERN UNIVERSITY, Ft. Lauderdale, FL (US)

(72) Inventors: Jolanta CZERWINSKA, Ft. Lauderdale, FL (US); Graciela ARMAYOR, Ft. Lauderdale, FL (US); Rochelle NAPPI, Ft. Lauderdale, FL (US); Robert MCGORY, Ft. Lauderdale, FL (US); Jeffrey JURKAS, Ft. Lauderdale, FL (US)

(21) Appl. No.: 17/059,392

(22) PCT Filed: May 31, 2019
(86) PCT No.: PCT/US2019/034867

§ 371 Date: Nov. 27, 2020

Related U.S. Application Data
(60) Provisional application No. 62/678,720, filed on May 31, 2018.

(51) Int. Cl. G06Q 50/20; G06Q 10/10

(52) U.S. Cl. CPC G06Q 50/20; G06Q 10/10

(57) ABSTRACT

A requirements tracking system for maintaining individual compliance records is provided. The records indicate which requirements having different respective requirement types have been satisfied by which individual members. A first requirement type requires participation in approved live programming sessions. First user input defining a proposed session and second user input for an unapproved session are received using different standardized user interface templates. The former specifies an applicable predefined domain, a location, and attributes. When user input is received, a dynamically-defined computer-mediated approval workflow is initiated. The associated session is approved, conditioned on the workflow being successful. Electronic signals are received from user devices as approved and unapproved sessions are attended by users. The records are updated based on the signals and conditioned on verification information. The verification information purports to verify participation in the respective sessions. The verification information type varies based on the session type associated therewith.

### CROSS-REFERENCE TO RELATED APPLICATION

This application claims the benefit of U.S. Application Ser. No. 62/678,720 filed on May 31, 2018, the entire contents of which are hereby incorporated herein by reference.

### BACKGROUND AND SUMMARY

Requirement tracking and certification systems are used in a wide variety of different contexts. For example, software developers working on large projects sometimes interact with software tools that help manage tasks to be completed in furtherance of those projects. In this regard, functions to be programmed, interfaces to be created, bugs to be fixed, routines to be tested, etc., may be defined and then assigned to and/or picked up by individuals who then are responsible for working on the same. Once a particular piece of work is completed, the individual(s) responsible typically can submit the work and then move on to the next task. In this paradigm, requirements typically are centrally defined but then are processed by multiple individuals who work on a common overarching project. In other words, multiple people work on oftentimes centrally-defined required tasks in connection with one project. In some instances, developers can note problems that they encounter (e.g., bugs, missing libraries, desired interfaces, etc.) so that, for example, such tasks can be defined and distributed to the team. Characteristically, however, one product is being produced as the multiple requirements are met.

In a somewhat related vein, factories that produce batches of common products will have attendant requirements and certifications that may need to be met. For instance, electrical signals may be provided to semiconductor devices to compare output signals against expected values to test whether the devices work as specified in their design specifications, vehicles such as automobiles may be crash-tested, airplane safety systems may be checked for fault tolerance, HVAC systems may be checked for Energy Star compliance and noise output levels, glass sheets may be checked for temper strength, shoes may be hand-inspected, etc. A product may be tested against an industry-defined standard, for compliance with a well-known certification, in connection with internal quality control measures, and/or the like. In some instances, independent auditors will perform such checks. In other instances, products may be self-certified as compliant with a standard, in conformance with expectations, etc. Typically, this paradigm involves multiple products are being tested by multiple individuals or teams of individuals for compliance with more-or-less centrally-defined requirements.

Educational programs can prepare students for careers in practice, research, industry, academia, and beyond. Creative and entrepreneurial programs, particularly at the higher education level, oftentimes are concerned with the personal and professional development of the students they are educating. To help prepare students for their careers, some degree programs have sought to provide educational experiences that supplement classroom and curricular activities with needed and/or desirable knowledge, skills, attitudes, and the like, e.g., through co-curricular events and activities. Although such co-curricular events and activities take place beyond the classroom, they nonetheless may be required aspects of the degree program and/or a particular course within a degree program.

Some educational institutions have well-defined co-curricular programs. And consistent with the above, an educational institution oftentimes will want to guide students to participate in co-curricular events and activities that complement curricular experiences to enhance students' personal and professional development. Depending on the structure of the co-curricular program, a personal and/or professional development “checklist” or the like may be established, and it may map events and activities to identified domain, subdomain, and/or other learning objectives, independent “stewardship” categories, and/or the like. For instance, a school of pharmacy might want to map co-curricular events and activities to the CAPE domains of self-awareness, leadership, professionalism, innovation and entrepreneurship, as well as a pride in university stewardship area. The following table provides a concrete example of such a mapping in this context.

| Domain | Sample Event/Activity Type | Sample Event/Activity |
|---|---|---|
| Professionalism | Health Fair/Patient Screening/ | Day for Children, Interprofessional |
| | Education | Diabetes Education and Awareness, |
| | | Kidney Walk |
| | Professional Application/Skills | Patient Counseling, Compounding, |
| | Competition | and Clinical Skills Competition, |
| | | Ethics Bowl |
| | Career Development-Lecture, | CV Development/Review |
| | Seminar, Workshop | Workshop, Interview Skills |
| | | Workshop |
| | | Residency Showcase & Workshop, |
| | | Residency Bootcamp |
| | Membership in Professional | APhA, ASHP, Kappa Psi, etc. |
| | Organization/Fraternity | |
| Leadership | Presentation at Professional | ASHP Midyear Meeting, FSHP and |
| | Meeting (national, state or local) | FPA Annual Meeting PR |
| | | Pharmacist Convention/Assembly |
| | Leadership Development-Lecture, | Leadership Workshop, Legislative |
| | Seminar, Workshop, Event | Day, New Student Orientation |
| | Leadership Role | Dean's Ambassador, COP class/ |
| | | organization/fraternity-Officer, |
| | | Peer Tutor, Peer Mentor, College |
| | | Committee Member, Phi Lambda |
| | | Sigma Member |
| Innovation & | Business Application-Lecture, | Business Seminar, PharmaCon, |
| Entrepreneurship | Seminar, Workshop or Event | Farmacias Aliadas Business |
| | | Orientation |
| | | NCPA: Successful Pharmacy |
| | | Ownership |
| | Research | Research conducted with faculty or |
| | | other researcher where student is |
| | | not paid |
| | Business Application-Creator of | Creator of new pharmacy service, |
| | product or service | program, technology, or education |
| | | materials |
| Self-Awareness | Self-Improvement-Lecture, | Study Skills & Test Taking |
| | Seminar, Workshop, Event | Strategies Workshop, How to Be |
| | | Outstanding Seminar |
| | Cultural Awareness-Lecture, | Humanism in Medicine Seminar, |
| | Seminar, Workshop or Event | Multicultural Family Feud, |
| | | Diversity Dialogue Panel, |
| | | Multicultural Fair |
| Pride | University or College Event | Campus Tours, Open House, |
| | | Welcome Back Week Social, |
| | | Distinguished Alumni Forum, |
| | | Alumni Reunion, Athletics Family |
| | | Night, Community Fest |

As alluded to above, participation in a co-curriculum program may be a required component of degree program. In some instances, co-curricular programs may be linked to core didactic courses in one or more years (e.g., each year) of the curriculum. A student may have to complete a minimum number of co-curriculum events and/or activities on a predetermined timescale (e.g., 5 events and/or activities per semester). Depending on the program, the events and/or activities may need to be approved or pre-approved by an authorized party (e.g., by a student services department, the college, university, and/or the like). Also depending on the program, students may have at least some flexibility to select what events and/or activities to participate in, when fulfilling program requirements. For instance, students (with or without consultation from an academic advisor or other person) may determine specific, measureable, achievable, relevant, and time-limited (SMART) goals for their profession growth, and participate in co-curricular events and/or activities to fulfill such SMART goals.

Completion of co-curricular events and/or activities may be tracked by completing forms. FIG. 1 is an example form that may be used in this regard. As can be seen from FIG. 1, students may be asked to identify themselves (e.g., with name and student identification number), the relevant course and event/activity, which domain the event/activity applies to, how the event/activity applies to that domain, etc. Students may sometimes be asked to reflect on the impact of such activities and the SMART goals throughout the students' participation in the course of study.

Educational institutions have used student portfolios to help track the completion of degree program and/or course requirements. Electronic portfolios, for example, can be used to store student achievements, create real-time professional curriculum vitae (CVs), etc. Records indicating completion of co-curricular events and/or activities, and accompanying reflections, may be made a part of a student's portfolio, as well. Doing so may provide a central repository for course-related documents and, for example, provide a convenient way for determining whether students have fulfilled degree requirements and/or are making adequate progress towards the same.

The current paper system unfortunately has several limitations. For example, it has been observed that students have not frequented a number of events/activities, simply because they were not aware of them. In other words, requirements have not been met in some instances simply because participants were unaware of potential ways in which they could be completed. Students have also had difficulties completing forms, e.g., in terms of logging events/activities under the incorrect domain, failing to timely submit forms, etc. Manual review and tabulation of events/activities for compliance and/or other purposes has been tedious and is an error-prone manual task. Furthermore, because of the timely and tedious manual processes involved, outcome data concerning quality and value of the events/activities typically is not available in a timely fashion.

Still further, like other requirements tracking and certification systems, requirements and certification tracking is complicated because of the “technological break” between satisfaction of a requirement and certification of that satisfaction. For instance, it can be difficult to verify that a centrally-defined requirement has been met when the corresponding event or activity requires real-world action that is decoupled from the technological reporting platform. Furthermore, basic information that an action is required, when the action can be provided, how the action is to be performed, etc., may not be shared among the central authority and individuals who might participate in the requirement, and this information distribution and communication problem can be especially frustrating when so many people are constantly connected through myriad different devices.

There are additional technical challenges that result from self-certification related practices. Such self-certification related practices in general may involve participation in an approved activity or event, or participation in an activity or event submitted for approval. For example, it can be difficult to know what activities or events might satisfy a given requirement, define an activity or event that might satisfy a given requirement in a standardized way that is easily understandable and verifiable, determine and enforce what party or parties have the right to seek approval and/or provide actual approval for activities or events, publicize how to seek approval, implement conditional approvals, etc. These technical challenges can be exacerbated in some contexts where activities or events that satisfy certain requirements can be defined and/or approved for multiple parties—especially where multiple different parties may seek approval for the same or similar activities or events in connection with the same or similar requirements. In other words, a given activity or event might be participated in by one or more parties for satisfaction of one or more different requirements by one or more of those parties. Requirements tracking in this sense can be difficult to implement because it is not always clear what activities or events map to which requirements and which parties are seeking which mappings. Further complications can arise because a particular requirement sometimes can be met in multiple different ways by the same or different parties, and because a given way of meeting a particular requirement can be engaged in by multiple different parties in some instances.

Certain example embodiments address these and/or other technological concerns.

In certain example embodiments, a requirements tracking system for maintaining a plurality of individual compliance records is provided. A non-transitory data store is configured to store the individual compliance records. Each individual compliance record includes information indicating an extent to which a plurality of requirements having different respective requirement types have been satisfied by an individual member associated with the respective individual compliance record. The requirements are satisfiable in different ways by different individual members. A first requirement has a first requirement type requiring real-time participation in a plurality of approved live programming sessions. Each approved live programming session is assigned to one of a plurality of predefined domains. Different individual members are able to satisfy the first requirement by participating in different sets of the approved live programming sessions. Processing resources include at least one processor and a memory coupled thereto. The processing resources are configured to perform functionality embedded in computer-programmed instructions for performing tasks. For instance, the processing resources are configured to at least receive first user input defining a proposed live programming session, with the first user input being receivable in accordance with a first standardized user interface template facilitating specification of at least (a) one of the plurality of predefined domains applicable to the proposed live programming session being defined, (b) a location for the proposed live programming session being defined, and (c) one or more additional attributes of the proposed live programming session being defined. Responsive to receipt of first user input defining the proposed live programming session: a first computer-mediated approval workflow is initiated for the proposed live programming session, with the first computer-mediated approval workflow being defined dynamically based on user credentials of the party providing the received first user input and content of the received first user input; and the proposed live programming session is designated as being one of the approved live programming sessions, conditioned on a successful outcome of the initiated first computer-mediated approval workflow. Second user input is received for an unapproved live programming session, with the second user input being receivable in accordance with a second standardized user interface template provided that the unapproved live programming session is of a first type and in accordance with a third standardized user interface template provided that the unapproved live programming session is of a second type, and with the first and second types being different from one another. Responsive to receipt of second user input for the unapproved live programming session: a second computer-mediated approval workflow is initiated for the unapproved live programming session, with the second computer-mediated approval workflow being defined dynamically based whether the unapproved live programming session is of the first type or of the second type; and the unapproved live programming session is designated as being one of the approved live programming sessions, conditioned on a successful outcome of the initiated second computer-mediated approval workflow. Electronic signals are received from user devices as approved and unapproved live programming sessions are attended by users using those respective user devices, each of these sessions having an associated session type. The individual compliance records are updated based on the received electronic signals and conditioned on verification information received in connection with the received electronic signals. The verification information purports to verify participation in the respective sessions by the users of the respective user devices. The verification information has a verification information type variable based on the session type associated with the respective session.

Corresponding methods, programs, computer readable storage media storing such programs, and/or the like, are also contemplated herein.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is an example paper form that may be used to track co-curricular event and/or activity participation;

FIG. 2 is a block diagram showing example components that may be used in connection with certain example embodiments;

FIG. 3 is a screenshot of an administrator portal screen, enabling an administrator to take a number of actions, in accordance with certain example embodiments;

FIG. 4 is a screenshot demonstrating how event/activity approval processing may take place, in accordance with certain example embodiments;

FIG. 5 is an example screenshot of a calendar that may be used in connection with certain example embodiments;

FIG. 6 is an example login screen that may be used in connection with the app of certain example embodiments;

FIG. 7 is an example screenshot for activity/event experience selection, in accordance with certain example embodiments;

FIG. 8 is an example screenshot for participation signoff, in accordance with certain example embodiments;

FIG. 9 is a screenshot for an unlisted event that may be used in connection with certain example embodiments;

FIG. 10 is a screenshot for an unlisted activity that may be used in connection with certain example embodiments;

FIG. 11 is a screenshot that may be used to gather feedback about an event, in accordance with certain example embodiments;

FIG. 12 is an example screenshot for viewing events/activities that have been recorded, which may be used in connection with certain example embodiments;

FIG. 13 is an example screenshot of a student portfolio, which may be used in connection with certain example embodiments;

FIG. 14 is an example report showing how captured data may be visualized in connection with certain example embodiments;

FIG. 15 is a block diagram showing a requirements tracking system in accordance with certain example embodiments; and

FIG. 16 is a schematic view demonstrating how requirements and conditions can be grouped, and how sessions can be approved, in accordance with certain example embodiments.

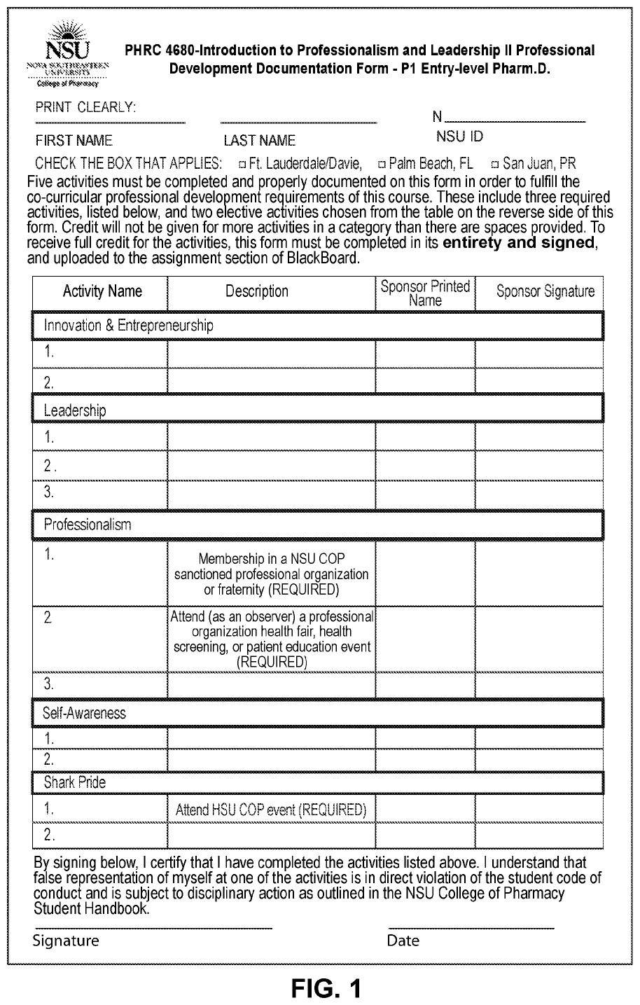

### DETAILED DESCRIPTION

Certain example embodiments provide a more centralized system to help define, manage, and publish events, while also capturing student participation and making it possible to collect outcome-related data on co-curriculum events/activities. Certain example embodiments thus in essence digitize the “paperwork” associated with defining co-curricular events and/or activities, tracking participation in such co-curricular events and/or activities, and provide a seamless electronic interface between such systems and the “portfolio” related system that helps track individual student progress towards overall degree or program goals.

Certain example embodiments combine a software backend with an application that can run on a mobile device (an app) to provide these and/or other functions. For example, a software application may help with the definition and management of activities and/or events, as well as the publication of such activities and/or events to relevant stakeholders. The app may help to capture student participation in co-curricular events and/or activities, facilitate reporting of attendance and/or other data related to the participation, and cooperate with the software backend to provide outcome and/or other data.

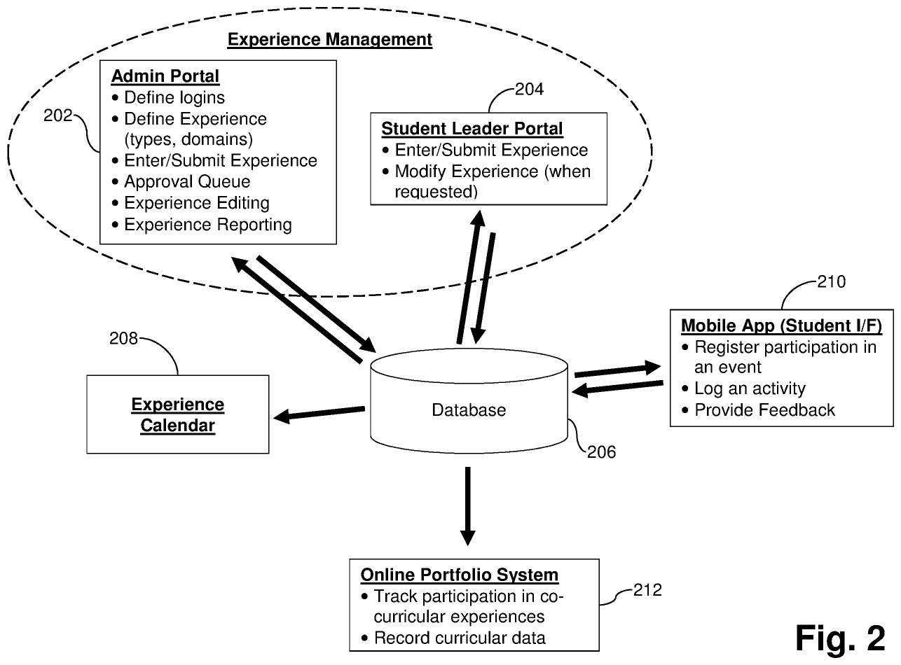

FIG. 2 is a block diagram showing example components that may be used in connection with certain example embodiments. As shown in FIG. 2, events management features are provided via an admin portal 202 and a student leader portal 204. These portals 202 and 204 may be accessible using a standalone application on a computer, via a web interface, and/or the like. The admin portal 202 enables authorized users to define logins for co-curricular experiences and actually create different co-curricular experiences (including both events and activities). The creation of co-curricular experiences will be outlined in greater detail below but, in brief, this feature enables authorized users to associate experiences with concrete types and domains. Admin-created events can be entered and submitted. If student leaders create new experiences or propose other experiences for inclusion in the list of co-curricular experiences that qualify towards satisfying a course requirement (e.g., via the student leader portal 204, discussed below), the admin portal 202 may be used to approve such events. In this sense, an approval queue may be maintained, and the approval process may integrate with an external workflow management or other system, e.g., to ensure that the proposals are retrieved, space is reserved as appropriate, students who submit such experiences for approval and/or sponsors of such experiences are kept abreast of the approval process, etc. Experiences, once created, may be edited (e.g., to reflect a change to the schedule, venue, description, etc.). Reports on experiences also may be accessed from the admin portal. The reports may provide summary information about how many people participated in the experience, how the experience was rated, what SMART objectives the experience was seen to benefit, etc.

As alluded to above, the student leader portal 204 enables experiences to be entered and submitted to the system, e.g., for approval and potential acceptance as fulfilling a co-curriculum requirement. This portal 204 may be used to modify an experience, e.g., upon the request of an authorized user in accordance with approval queue processing via the admin portal 202, to reflect a change in time/date/venue, etc. For instance, an admin approver might want to see additional information about the proposed experience, the admin approver may correct the submitted domain associated with the experience, and/or the like.

Information received from these portals may be communicated to a database 206 (e.g., an Oracle database or other structured data store). Correspondingly, relevant information about experiences may be retrieved from the databases when needed by the admin portal and/or the student leader portal. For instance, information about approved experiences may be stored to the database 206, as may information about newly defined experiences that are awaiting approval. As an example, a student may use the student leader portal 204 to initiate the creation of a new experience, and the corresponding information may be stored to the database 206. An approval queue may be updated accordingly, and the corresponding data may be retrieved from the database 206 for display via the admin portal 202 during the experience approval process. Likewise, information concerning requests for changes, ultimate approvals, and/or the like, may be transmitted from the admin portal 202 back to the database so that the student can retrieve this information from the database 206 and see it via the student leader portal 204.

In a somewhat similar fashion, an online experience calendar 208 may be generated based on information from the database 206. That is, an HTML or other calendar may be generated automatically and programmatically based on data stored to the database 206. Calendar entries may indicate the time, date, and location for a given experience, along with the experience's name, a brief description, and information about the domain(s) with which it is associated. The online events calendar 208 may be searchable by date, time, location, domain, and/or the like, in certain example embodiments. It may be accessed via a standalone computer, and/or via the mobile app.

The mobile app 210 provides an interface to the system for students. Using the app 210, students can register participation in an event, log the completion of an activity, provide feedback for a given experience, etc. The app 210 may be run on any suitable smart device (e.g., a smart phone, tablet, and/or the like). In certain example embodiments, the same or similar features may be accessible using a standalone application on a computer, via a web interface, and/or the like.

The online portfolio system 212 may be used to track participation in co-curricular experiences, record curricular data, generate CVs, etc. It may pull information from the database 206 for these and/or other purposes.

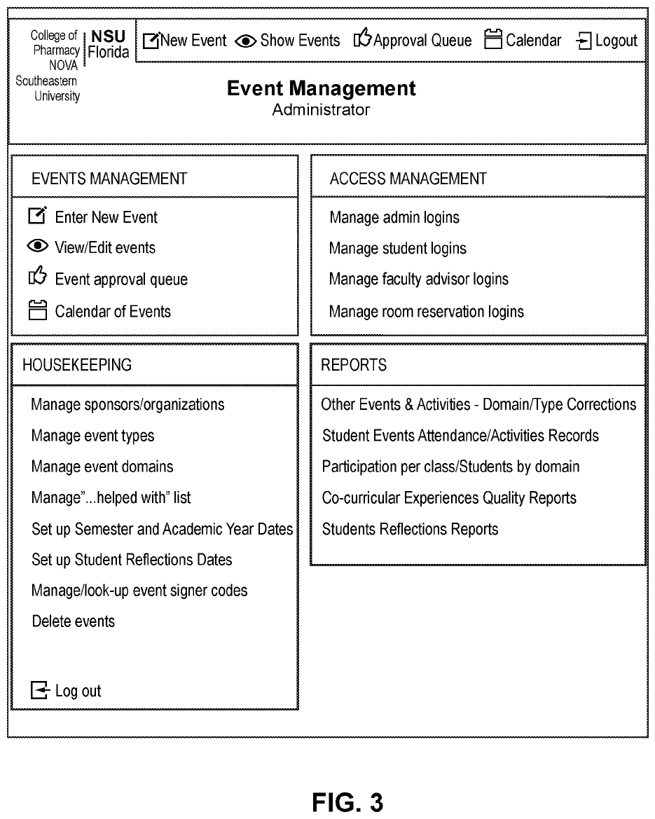

FIG. 3 is a screenshot of an administrator portal screen, enabling an administrator to take a number of actions, in accordance with certain example embodiments. Tasks performable using this screen include, for example:
Entering/modifying activity/event experiences including, for example, title, date, location, sponsor, description, room/service needs, etc.;
Monitoring the flow of approval of an experience for co-curricular and/or other “credit” (e.g., viewing faculty advisor, student affairs, room reservation/service, final approval, and/or other milestones in a defined approval process);
Approval of the activity/event experiences at various levels (e.g., faculty advisor, room assignment, etc.);
Specifying the general values for types of activity/event experiences and domains to be assigned to the same;
Managing users (e.g., students allowed to post an activity/event experience, faculty advisors, room/service persons, other administrators); and
Generation of reports of activity/event experiences, including participation-related and/or other metrics (e.g., generated per type of activity/event, domain, per student population, etc.).

A new event/activity experience may be defined in terms of its domain, type, date and time, location, name, etc. Example domains may include, for example, professionalism, leadership, innovation and entrepreneurship, self-awareness, pride, other, and/or non-curricular. Example types of experience may include, for example, practice of pharmacy or other applicable industry development, community service, career development, research, leadership development, career development, business application, cultural awareness, self-improvement, fundraiser, general student organization meeting, campus event, processional application/skills competition, professional association meeting, health fair/patent screening and/or education, college/department event, etc. These and/or the like may be specified in terms of, for example, lecture, seminar, workshop, event, etc., which may be selectable sub-categories in certain example embodiments.

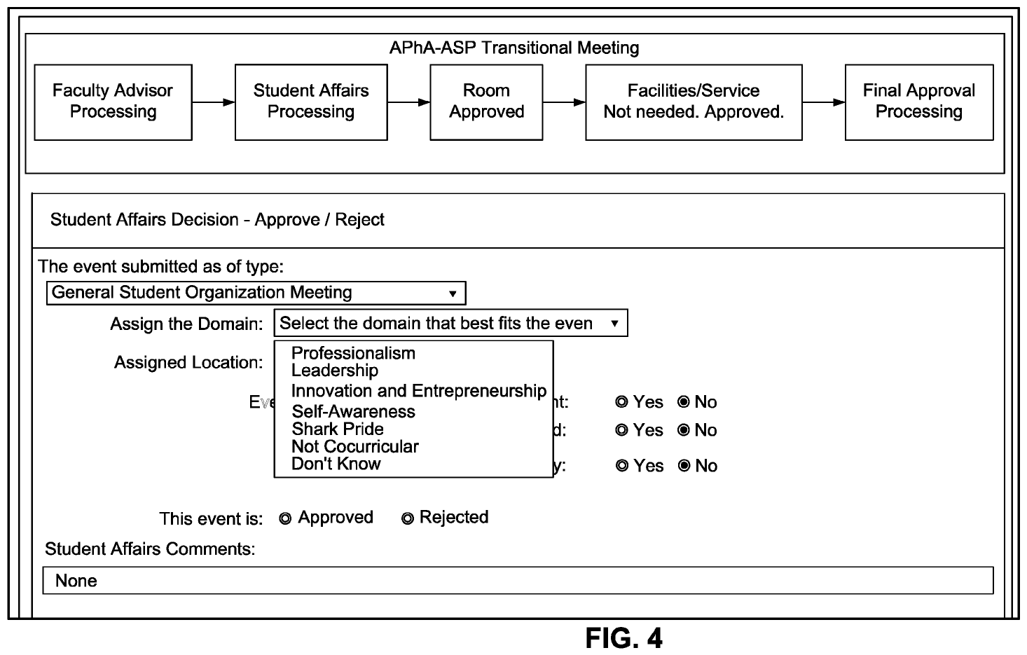

FIG. 4 is a screenshot demonstrating how event/activity approval processing may take place, in accordance with certain example embodiments. FIG. 4 shows “APhA-ASP transitional meeting” as the name of the co-curricular event, and provides an overview of the approval workflow. In this example, a faculty advisor, student affairs group, room reservation system, and facilities/services management department, need to provide approval for the co-curricular activity. It will be appreciated that these and/or other groups may be needed for approval in different scenarios. In the FIG. 4 example, the room reservation and facilities/services management department have granted approval, but the other groups of individuals need to provide their approval before the co-curricular experience can be calendared. It will be appreciated that the facilities/services management department need not necessarily be consulted, and/or approval may be automatically granted, in this example instance, because nothing “extra” is needed from them. It will be appreciated that the workflow may require serial processing in some instances but, in other instances (including this one), approvals may be granted “out-of-turn.” That is, approval for the room and facilities/services has been granted even though they are at least notionally “downstream” of faculty advisor and student affairs approvals. It will be appreciated that different approval approaches may be used in connection with events as opposed to activities, in some instances. It also will be appreciated that different approval approaches may be used in connection with different events (e.g., based on where events are to take place, whether school resources are to be used, etc.).

Referring once again to the details of the FIG. 4 example screenshot, it will be appreciated that the screenshot assumes that the student affairs administrator has logged in and is providing approvals. In certain example embodiments, some or all administrators may be empowered to change or suggest changes to certain defined fields. In this instance, power is given to change the domain type. A comment field is provided, e.g., so that other notes can be offered up in connection with the particular event/activity. Although partially obscured in the FIG. 4, other options for indicating whether the event has an interprofessional component, whether certificates will be issued, whether the event is a co-curricular activity, etc., may be provided.

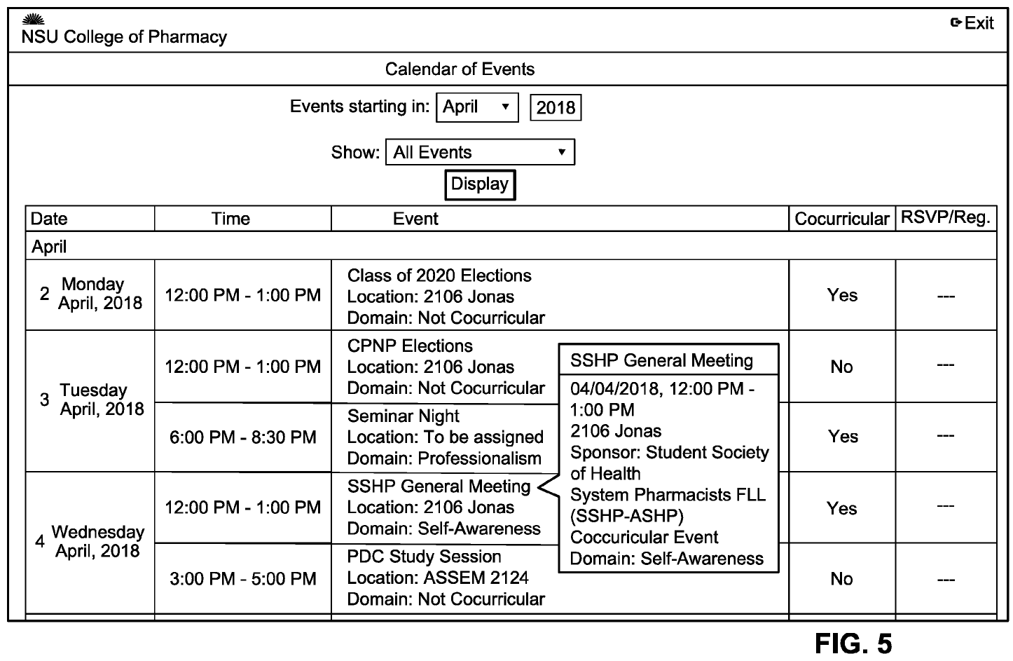

Approved events may be displayed using the online calendar function, as noted above. In this regard, FIG. 5 is an example screenshot of a calendar that may be used in connection with certain example embodiments. The FIG. 5 example calendar lists approved events for different date entries on the calendar, along with the times. Basic name/identification information is displayed, as is the location, domain (if applicable), and flags indicating whether the event is co-curricular and whether RSVP/registration is needed. In certain example embodiments, hovering over or clicking a name/identifier will display additional information such as, for example, the sponsor, a brief description, etc. In certain example embodiments, clicking on a name/identifier will enable a user to sign in and register for or RSVP for the event. The data for completing the calendar may be retrieved from the database, and the RSVP/registration also may be performed in connection with the database.

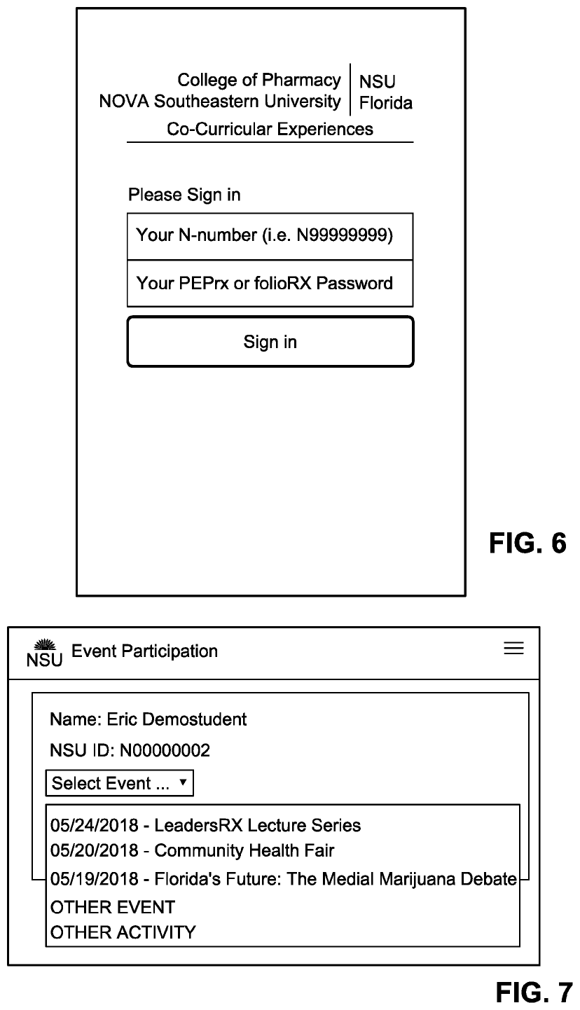

FIG. 6 is an example login screen that may be used in connection with the app of certain example embodiments. FIG. 6 prompts for a username and password combination. The former may be, for example, a student identification number, email address, portfolio identifier, a username specific to this system, etc. The password may be a password specific to this system, the same password used for some/all school related functionality, etc. Once logged in, the student participation app allows a student to select an activity/event from a list populated from the database based on activities/events approved by the administrator portal. Activities and/or events for which a student may wish to get approval later may be selected through “other” categories. FIG. 7 is an example screenshot for activity/event experience selection, in accordance with certain example embodiments.

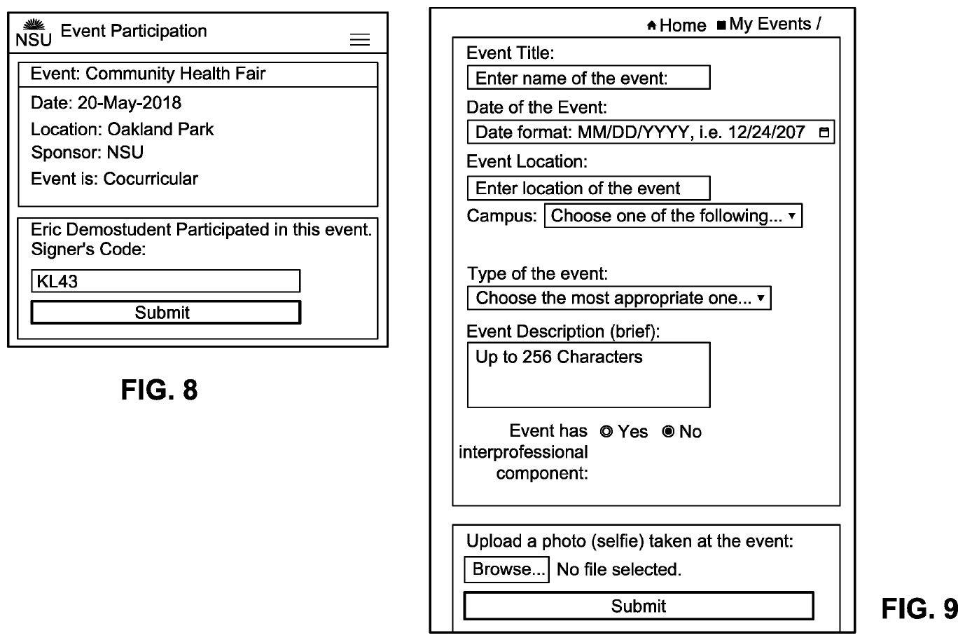

Certain operations may be performed to digitally and reliably confirm/authenticate the student's participation at the event. The app of certain example embodiments may help in this regard. For example, FIG. 8 is an example screenshot for participation signoff, in accordance with certain example embodiments. Proof of participation may be provided by having a person at the event/activity enter a code into the app. The person may quickly verify that the correct event/activity is involved based on the information displayed. ID of the student may be presented and compared with on-screen information, in some instances. Furthermore, GPS or other location services of the mobile device running the app may be activated, e.g., to obtain a physical location of the device. That may be then cross-checked with the expected location (e.g., as provided by the admin portal), with or without time information as well. A student additionally or alternatively may be asked to take photo-documentary evidence of attendance. This may be, for example, a selfie at a specified location (e.g., in front of a welcome sign, in an auditorium, etc.). In-built camera functionality of the smart device hosting the app may be used in this regard. Location and/or time information can be gathered here in addition to, or apart from, the above. It will be appreciated that different levels of authentication may be provided for different experience types in different implementations. For example, more robust metrics may be provided for events (e.g., signers may need to provide codes), as compared to activities (e.g., where selfies may suffice). Because events are more likely to be staffed with authorized persons, this may be possible.

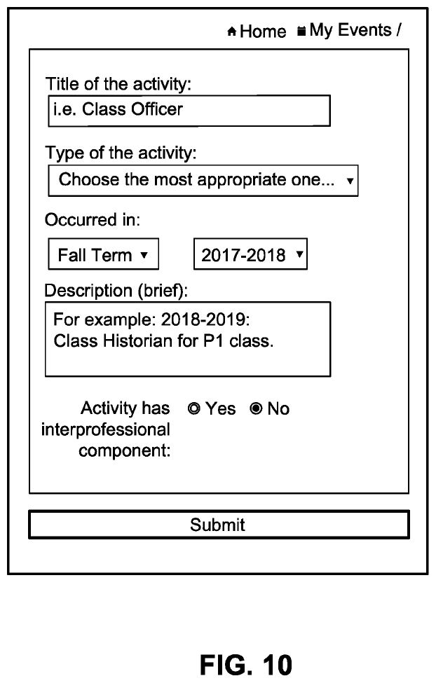

Selection of an “other” category may prompt different displays, e.g., prior to, and possibly without, FIG. 8. For instance, FIG. 9 is a screenshot for an unlisted event that may be used in connection with certain example embodiments, and FIG. 10 is a screenshot for an unlisted activity that may be used in connection with certain example embodiments. The student may be prompted to input identification information, date/time/location information, a brief description of the activity/event, etc. The student may be asked to provide corroborating evidence of attendance and participation such as, for example, a selfie. This information may be akin to that receivable using the student leader portal and may trigger the same or similar approval processes, albeit for events/activities that have already taken place. Information about whether there is an interprofessional component (e.g., involving actively working with a member of another profession, including students) also may be solicited. This other/unlisted experience feature may be useful for participating in activities such as, for example, being a class officer, which have co-curricular applicability but do not necessarily lend themselves well to being predefined and involving a date certain.

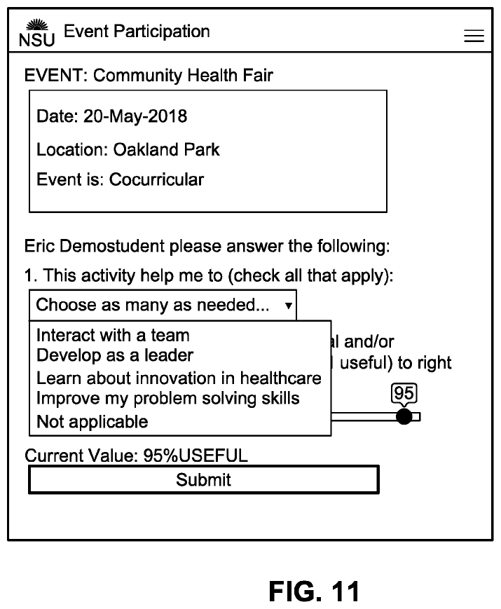

FIG. 11 is a screenshot that may be used to gather feedback about an event, in accordance with certain example embodiments. This information may include a brief survey, for example, asking the student to indicate what objectives were met by the experience, to provide an overall usefulness gauge of the experience (e.g., a ranking from 0-100%, a letter grade, a number of stars, etc.). Freeform notes also may be accepted in certain example embodiments.

A confirmation screen may be presented, e.g., to signify that participation in the event or activity has been submitted.

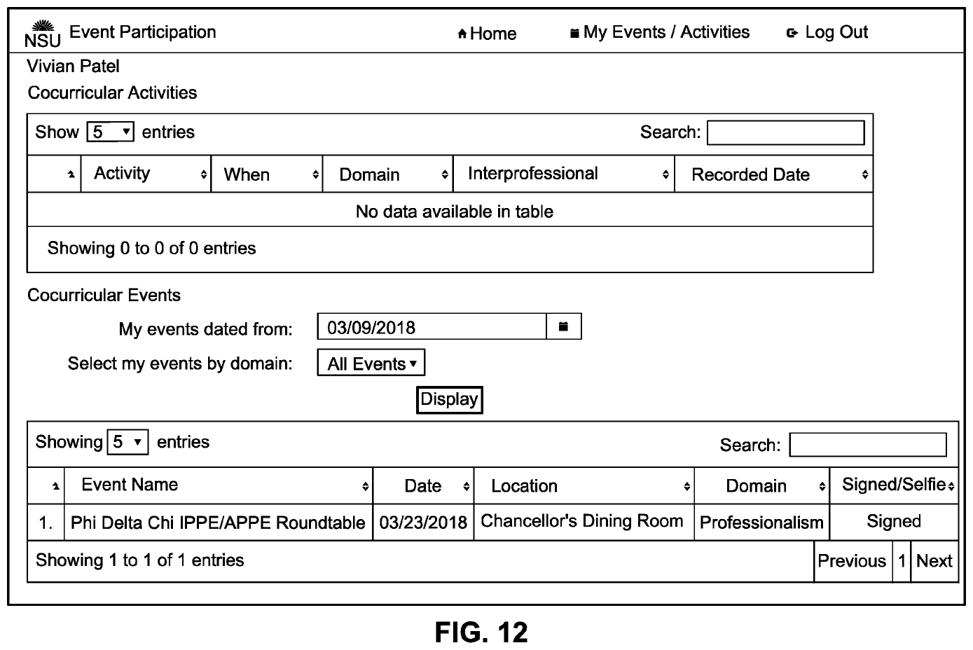

FIG. 12 is an example screenshot for viewing events/activities that have been recorded, which may be used in connection with certain example embodiments. A student may use this screen to track what experiences have been attended, determine whether follow-up action is needed (e.g., submit a newly-created survey, track approval for an unlisted activity/event, etc.).

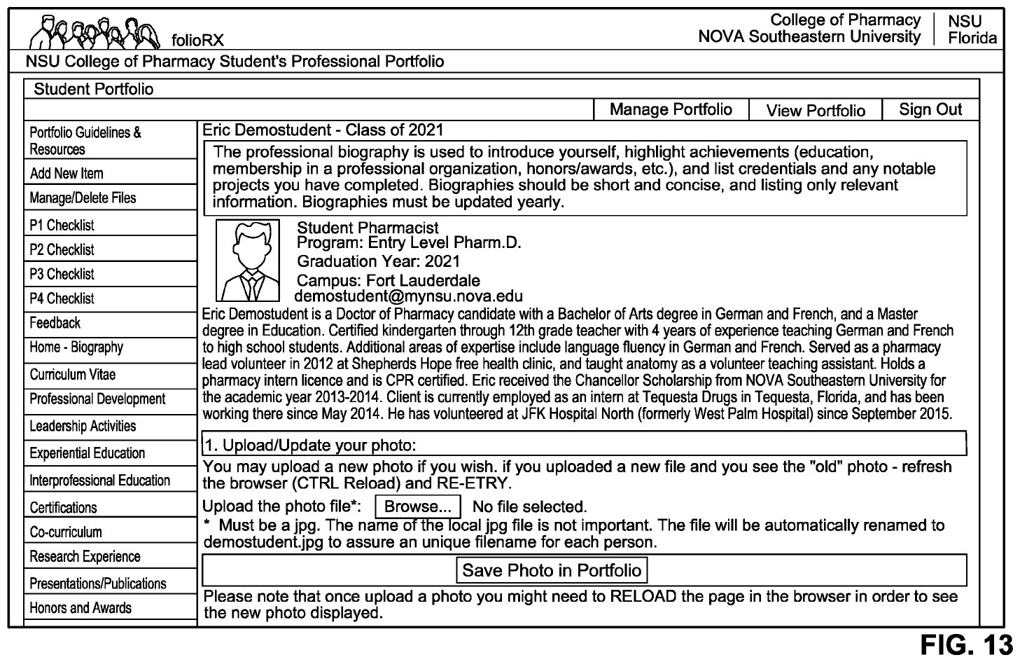

The FIG. 12 information may be viewable from the student's portfolio in certain example embodiments. FIG. 13 is an example screenshot of a student portfolio, which may be used in connection with certain example embodiments. By selecting the “Co-curriculum” link in FIG. 13, the FIG. 12 screen (or one like it) may be displayed. Thus, it will be appreciated that there is a technical integration of the event planning and student portfolio systems provided in certain example embodiments, e.g., via the database.

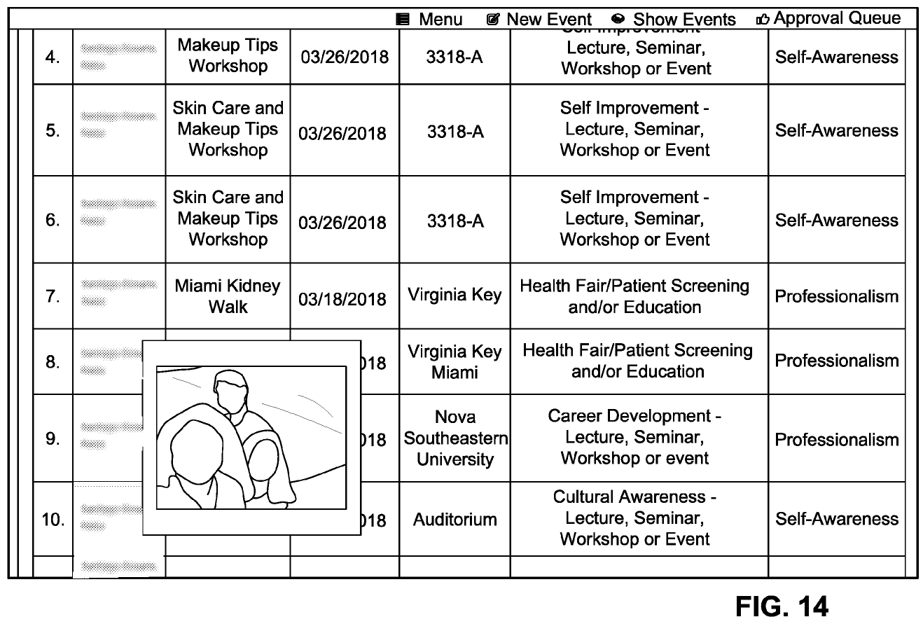

FIG. 14 is an example report showing how captured data may be visualized in connection with certain example embodiments. The FIG. 14 report lists attendees at different events, along with dates, locations, event types, and domains, that are associated with the entries. Hovering over a name in this example retrieves and displays the picture associated with the event. Hovering over the event description may present more detailed information about it (e.g., date, time, location, sponsor, etc.). An authorized admin user may filter results based on a particular event, event type, domain, date or date range, etc. Similarly, an authorized admin may view data for a specific student or students. It will be appreciated that this data may be retrieved from the database using SQL and/or other queries.

Certain example embodiments are technically advantageous in the sense that they can provide digital authentication for real-world events using in-built features of smart devices. Furthermore, certain example embodiments help solve data quality and data auditing issues by providing a common format that talks to disparate systems (e.g., records-related portfolio-type systems and event management systems), while also providing different views into the data to different users of each system and to the different systems generally. This is enabled in certain example implementations by using well-structured data and well-defined workflows that can provide consistent, comparable, and objective descriptions of very different types of events/activities.

Although certain example embodiments have been described in connection with pharmacy schools, it will be appreciated that the example technology may be applied to different areas of study and/or at different levels of education. It also will be appreciated that the technology disclosed herein may be used in connection with non-educational related events/activities, e.g., where there is a desire to perhaps better track where individuals attend certain known and/or pre-planned goings-on.

In a related vein, although certain example embodiments have been described in connection with certain example domains and event types, it will be appreciated that other domains and event types tailored for the particular application may be used in place, or together with, some or all of the example domain types discussed herein. Similar comments also apply to the objectives being defined in connection with the SMART and/or other categories.

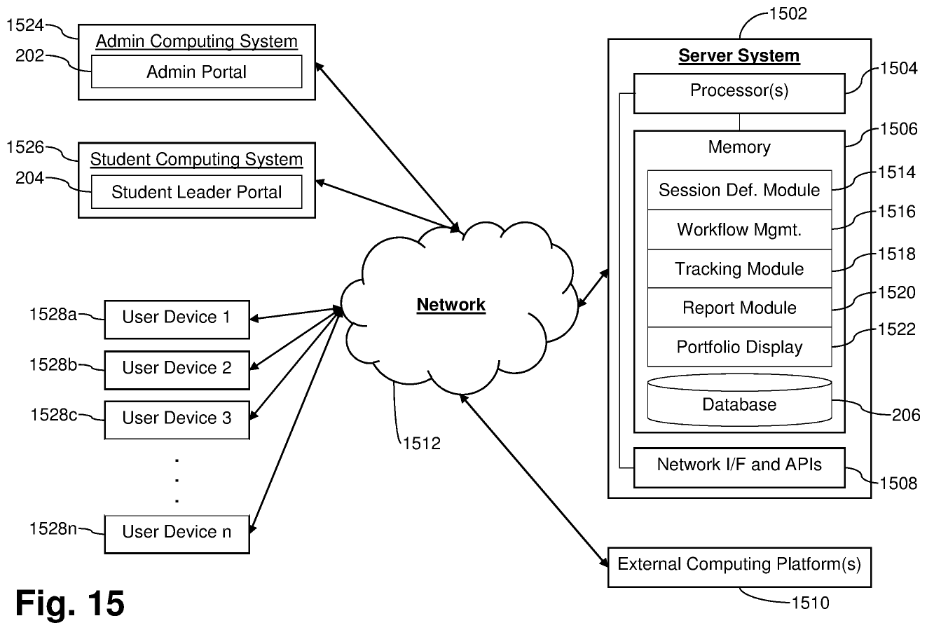

FIG. 15 is a block diagram showing a requirements tracking system in accordance with certain example embodiments. The FIG. 15 system maintains a plurality of individual compliance records, e.g., in the database 206 or in a separate data store (which may be in and/or accessible to the server system 1502, the external computing platform(s) 1510 and/or the like). Each individual compliance record in this store includes information indicating an extent to which a plurality of requirements having different respective requirement types have been satisfied by an individual member associated with the respective individual compliance record. The requirements are satisfiable in different ways by different individual members. In an educational context, for example, students may complete degree requirements by taking different sets of classes to fulfill curricular requirements, and co-curricular activities may be required as a separate set of requirements. As will be appreciated from the description above, and consistent with the former, a first requirement may have a first requirement type requiring real-time participation in a plurality of approved live programming sessions, with each approved live programming session being assigned to one of a plurality of predefined domains. And similar to as described above, different individual members may be able to satisfy the first requirement by participating in different sets of the approved live programming sessions.

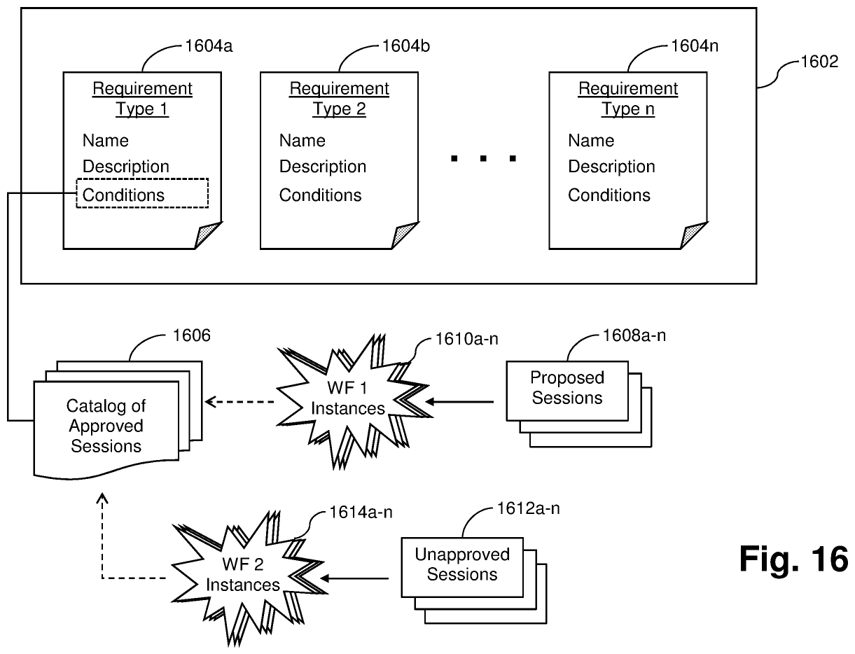

In this vein, FIG. 16 is a schematic view demonstrating how requirements and conditions can be grouped, and how sessions can be approved, in accordance with certain example embodiments. FIG. 16 shows a requirements grouping 1602, which includes a plurality of different requirements 1604a-1604n having different respective requirements types. Each one of the different requirements 1604a-1604n has a name, description, and conditions for its satisfaction. The first requirement type 1604a is conditioned on the completion of a plurality of real-time live programming sessions (e.g., events and/or activities) included in a catalog of approved sessions 1606.

Referring once again to FIG. 15, the server system 1502 includes processing resources including at least one processor 1504 and a memory 1506 operably coupled thereto. The server system 1502 further includes a network interface and application programming interfaces (APIs) 1508 for communicating with the external computing platform(s) 1510 and/or the network 1512 (including devices connected to the network 1512, as will be described in greater detail below). The memory 1506 in the FIG. 15 example includes the database 206, as well as a series of program modules. These program modules support the functionality described above. They may be implemented in any suitable programming language and they may be interfaced with via dedicated applications, through a web interface accessible via portals, etc. In this regard, the administrative computing system 1524 may host or provide access to the admin portal 202, the student computing system 1526 may host or provide access to the student leader portal 204, etc. The administrative computing system 1524 and the student computing system 1526 may be standalone machines, handheld devices such as smart phones or the like, etc. In this sense, they may include their own respective processing resources (including processors, memories, wireless adapters, etc.) and may communicate with the server system 1502 via the network 1512.

The admin portal 202, for example, may interface with the session definition module 1514. The session definition module 1514 may receive first user input defining a proposed live programming session, with the first user input being receivable in accordance with a first standardized user interface template facilitating specification of at least (a) one of the plurality of predefined domains applicable to the proposed live programming session being defined, (b) a location for the proposed live programming session being defined, and (c) one or more additional attributes of the proposed live programming session being defined. See FIG. 4, for example, in this regard. Attributes of proposed live programming session may specify, for example, whether the event has an interprofessional component, whether certificates will be issued, whether the event is a co-curricular activity, etc. This and/or other information about a session may be stored as metadata or the like associated with the session.

Responsive to receipt of first user input defining the proposed live programming session, the session definition module 1514 may cooperate with the workflow management module 1516 to initiate a first computer-mediated approval workflow for the proposed live programming session. The first computer-mediated approval workflow may defined dynamically based on user credentials of the party providing the received first user input and content of the received first user input. The proposed live programming session may be designated as being one of the approved live programming sessions, conditioned on a successful outcome of the initiated first computer-mediated approval workflow.

This first workflow approval procedure is shown schematically in FIG. 16, with the proposed sessions 1608a-1608n triggering respective first workflow instances 1610a-1610n. The first workflow instances 1610a-1610n are dynamically defined. By cooperating with the external computing platform(s) 1510, for example, the workflow may be completed and, if there is a success, the associated successful proposed sessions will be added to the catalog of approved sessions 1606.

In a similar fashion, the session definition module 1514 may receive second user input for an unapproved live programming session, with the second user input being receivable in accordance with a second standardized user interface template provided that the unapproved live programming session is of a first type and in accordance with a third standardized user interface template provided that the unapproved live programming session is of a second type, and with the first and second types being different from one another. See FIGS. 9-10, for example, in this regard.

Responsive to receipt of second user input for the unapproved live programming session, the session definition module 1514 may cooperate with the workflow management module 1516 to initiate a second computer-mediated approval workflow for the unapproved live programming session. The second computer-mediated approval workflow may be defined dynamically based whether the unapproved live programming session is of the first type or of the second type. The unapproved live programming session may be designated as being one of the approved live programming sessions, conditioned on a successful outcome of the initiated second computer-mediated approval workflow.

This second workflow approval procedure is similar to the first workflow approval procedure described above and also is shown schematically in FIG. 16. The unapproved sessions 1612a-1612n triggering respective second workflow instances 1614a-1614n. The second workflow instances 1614a-1614n are dynamically defined. By cooperating with the external computing platform(s) 1510, for example, the workflow may be completed and, if there is a success, the associated successful proposed sessions will be added to the catalog of approved sessions 1606.

The first and/or second computer-mediated approval workflows may be dynamically defined to facilitate communication among and/or between computing platforms operated by one or more of an administrative authority responsible for granting final approval, a space and/or facilities manager, and users initiating the respective workflows. These computing platforms may be thought of as being the external computing platforms 1510 shown in FIG. 15. In some instances, the first and/or second computer-mediated approval workflows may permit messages to be passed between users of the different computing platforms. In certain example embodiments, the first and/or second computer-mediated approval workflows may be defined to be unidirectional and/or to permit operations only by the party with whom responsibility currently lies.

The server system 1502, using the tracking module 1518, is able to receive electronic signals from user devices 1528a-1528n as approved and unapproved live programming sessions are attended by users using those respective user devices 1528a-1528n. As will be appreciated from the above, each of these sessions having an associated session type (e.g., activity and event types). The tracking module 1518 also helps update the individual compliance records based on the received electronic signals, conditioned on verification information received in connection with the received electronic signals. The verification information in this regard purports to verify participation in the respective sessions by the users of the respective user devices 1528a-1528n.

The verification information may have a verification information type that varies based on the session type associated with the respective session. For example, a first verification information type may require a selfie picture taken with a camera of a user device of a user seeking to verify participation in a corresponding session (e.g., with a predetermined landmark in a viewable area thereof); a second verification information type may require a code to be input into a user device of a user seeking to verify participation in a corresponding session; a third verification information type may be based on submission of a post-session follow-up survey submission; a fourth verification information type may be self-verification based on a user indication of participation; and/or the like.

If a selfie is used as a form of verification, a face in the selfie picture may be compared with an identification photo for verification of participation. For example, facial recognition libraries may be accessed via the server system 1502 (e.g., through a web service call or the like) to compare the face in the selfie to an official identification photo of the user claiming participation in the session.

A variety of self-verification approaches may be used in different example embodiments. For example, a comparison may be made between a time and/or location from a user device of a user seeking to verify participation in a corresponding session, and stored time and/or location information for the corresponding session. For instance, the in-built clock and/or GPS device of a smart phone may be queried by an app running thereon, and the information obtained may be compared to session information in the database 206.

In certain example embodiments, the second user input may be accompanied by verification information having a fifth verification information type and purporting to verify participation in the unapproved live programming session by the party providing the received second user input. That is, when the person attends the activity or event and submits it for approval (and it is thus at least temporarily an unapproved session) then or thereafter, the fifth verification information type verification information may be provided. Thus, the fifth verification information type in some instances may require submission while at the unapproved live programming session. In other instances, the fifth verification information type may require submission within a predetermined amount of time following the unapproved live programming session.

Referring once again to FIG. 15, the report module 1520 may be configured to generate a display including information about the sessions. The report module 1520 may, for example, enable display of a list of approved, proposed, and/or unapproved live programming sessions. The list may be searchable and/or filterable in some instances. Furthermore, in certain example embodiments, the information about the sessions may include a session-by-session breakdown of: how many people participated in the respective session; a rating related to the respective session; a date and/or location of the respective session, a type, domain, requirement, objective, or other attribute, associated with the respective session; and/or which individual members participated in the respective session. The report module 1520 may be accessible via, and the display may be presented as, a webpage, with content of the webpage being variable based on credentials of the user accessing the report module. For instance, credentials may be different based on whether the report module 1520 is accessed via the admin portal 202, the student leader portal 204, and/or one of the user devices 1528a-1528n.

Similar to the report module 1520, the portfolio display module 1522 may be configured to generate a display including information about the sessions attended by a given individual member. The portfolio display module 1522 may, for example, enable display of a list of approved, proposed, and/or unapproved live programming sessions attended by the given individual member. The list may be searchable and/or filterable in some instances, e.g., based on session type, whether the session took place in the past or present, whether follow-up action is required, and/or the like. Furthermore, in certain example embodiments, the information about the sessions may include a session-by-session breakdown of: a date and/or location of the respective session, a type, domain, requirement, objective, or other attribute, associated with the respective session; and/or whether a follow-up action is needed for the respective session. The portfolio display module 1522 may be accessible via, and the display is presented as, a webpage, with the content of the webpage being variable based on an identity of the user accessing the portfolio display module. In some instances, the identity of the user will match with the given individual member, meaning that an individual member will only receive portfolio information for that particular member.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A requirements tracking system for maintaining a plurality of individual compliance records, the system comprising:
a non-transitory data store configured to store the individual compliance records, each individual compliance record including information indicating an extent to which a plurality of requirements having different respective requirement types have been satisfied by an individual member associated with the respective individual compliance record, the requirements being satisfiable in different ways by different individual members, a first requirement having a first requirement type requiring real-time participation in a plurality of approved live programming sessions, each approved live programming session being assigned to one of a plurality of predefined domains, different individual members being able to satisfy the first requirement by participating in different sets of the approved live programming sessions;
processing resources including at least one processor and a memory coupled thereto, the processing resources being configured to at least:
receive first user input defining a proposed live programming session, the first user input being receivable in accordance with a first standardized user interface template facilitating specification of at least (a) one of the plurality of predefined domains applicable to the proposed live programming session being defined, (b) a location for the proposed live programming session being defined, and (c) one or more additional attributes of the proposed live programming session being defined;
responsive to receipt of first user input defining the proposed live programming session:
initiate a first computer-mediated approval workflow for the proposed live programming session, the first computer-mediated approval workflow being defined dynamically based on user credentials of the party providing the received first user input and content of the received first user input; and
designate the proposed live programming session as being one of the approved live programming sessions, conditioned on a successful outcome of the initiated first computer-mediated approval workflow;
receive second user input for an unapproved live programming session, the second user input being receivable in accordance with a second standardized user interface template provided that the unapproved live programming session is of a first type and in accordance with a third standardized user interface template provided that the unapproved live programming session is of a second type, the first and second types being different from one another;
responsive to receipt of second user input for the unapproved live programming session:
initiate a second computer-mediated approval workflow for the unapproved live programming session, the second computer-mediated approval workflow being defined dynamically based whether the unapproved live programming session is of the first type or of the second type; and
designate the unapproved live programming session as being one of the approved live programming sessions, conditioned on a successful outcome of the initiated second computer-mediated approval workflow;
receive electronic signals from user devices as approved and unapproved live programming sessions are attended by users using those respective user devices, each of these sessions having an associated session type; and
update the individual compliance records based on the received electronic signals and conditioned on verification information received in connection with the received electronic signals, the verification information purporting to verify participation in the respective sessions by the users of the respective user devices, wherein the verification information has a verification information type variable based on the session type associated with the respective session.

2. (canceled)

3. The system of claim 1, wherein a first verification information type requires a selfie picture taken with a camera of a user device of a user seeking to verify participation in a corresponding session.

4. The system of claim 3, wherein the selfie picture is to be taken with a predetermined landmark in a viewable area thereof.

5. The system of claim 3, wherein the processing resources are further configured to compare a face in the selfie picture with an identification photo for verification of participation.

6. The system of claim 1, wherein a second verification information type requires a code input into a user device of a user seeking to verify participation in a corresponding session.

7. The system of claim 1, wherein a third verification information type is based on submission of a post-session follow-up survey submission.

8. The system of claim 1, wherein a fourth verification information type is a self-verification based on a user indication of participation.

9. The system of claim 8, wherein the self-verification compares a time and/or location from a user device of a user seeking to verify participation in a corresponding session with stored time and/or location information for the corresponding session to verify participation in a corresponding session.

10. The system of claim 1, wherein the second user input is accompanied by verification information having a fifth verification information type and purporting to verify participation in the unapproved live programming session by the party providing the received second user input.

11. The system of claim 10, wherein the fifth verification information type requires submission while at the unapproved live programming session or within a predetermined amount of time following the unapproved live programming session.

12. (canceled)

13. The system of claim 1, wherein the first and/or second computer-mediated approval workflows are dynamically defined to facilitate communication among and/or between computing platforms operated by one or more of an administrative authority responsible for granting final approval, a space and/or facilities manager, and users initiating the respective workflows.

14. The system of claim 13, wherein:
the first and/or second computer-mediated approval workflows permit messages to be passed between users of the different computing platforms, and/or
the first and/or second computer-mediated approval workflows is/are defined to be unidirectional and to permit operations only by the party with whom responsibility currently lies.

15. (canceled)

16. The system of claim 1, further comprising a report module executable by the processing resources, the report module being configured to generate a display including information about the sessions,
wherein the information about the sessions includes a list of approved, proposed, and unapproved live programming sessions, the list being searchable and/or filterable.

17-19. (canceled)

20. The system of claim 16, wherein the report module is accessible via, and the display is presented as, a webpage, content of the webpage being variable based on credentials of the user accessing the report module.

21. (canceled)

22. The system of claim 1, further comprising a portfolio display module executable by the processing resources, the portfolio display module being configured to generate a display including information about the sessions attended by a given individual member,
wherein the information about the sessions includes a list of approved, proposed, and unapproved live programming sessions attended by the given individual member, and
wherein the list is searchable and/or filterable based on session type, whether the session took place in the past or present, and/or whether follow-up action is required.

23-25. (canceled)

26. The system of claim 22, wherein the portfolio display module is accessible via, and the display is presented as, a webpage, content of the webpage being variable based on an identity of the user accessing the portfolio display module, and
wherein the identity of the user matches with the given individual member.

27. (canceled)

28. A method of maintaining a plurality of individual compliance records in connection with a requirements tracking system including at least one hardware processor and a memory coupled thereto, the method comprising:
having stored to a non-transitory data store the individual compliance records, each individual compliance record including information indicating an extent to which a plurality of requirements having different respective requirement types have been satisfied by an individual member associated with the respective individual compliance record, the requirements being satisfiable in different ways by different individual members, a first requirement having a first requirement type requiring real-time participation in a plurality of approved live programming sessions, each approved live programming session being assigned to one of a plurality of predefined domains, different individual members being able to satisfy the first requirement by participating in different sets of the approved live programming sessions;
receiving first user input defining a proposed live programming session, the first user input being receivable in accordance with a first standardized user interface template facilitating specification of at least (a) one of the plurality of predefined domains applicable to the proposed live programming session being defined, (b) a location for the proposed live programming session being defined, and (c) one or more additional attributes of the proposed live programming session being defined;
responsive to receipt of first user input defining the proposed live programming session:
initiating a first computer-mediated approval workflow for the proposed live programming session, the first computer-mediated approval workflow being defined dynamically based on user credentials of the party providing the received first user input and content of the received first user input; and
designating the proposed live programming session as being one of the approved live programming sessions, conditioned on a successful outcome of the initiated first computer-mediated approval workflow;
receiving second user input for an unapproved live programming session, the second user input being receivable in accordance with a second standardized user interface template provided that the unapproved live programming session is of a first type and in accordance with a third standardized user interface template provided that the unapproved live programming session is of a second type, the first and second types being different from one another;
responsive to receipt of second user input for the unapproved live programming session:
initiating a second computer-mediated approval workflow for the unapproved live programming session, the second computer-mediated approval workflow being defined dynamically based whether the unapproved live programming session is of the first type or of the second type; and
designating the unapproved live programming session as being one of the approved live programming sessions, conditioned on a successful outcome of the initiated second computer-mediated approval workflow;
enabling receipt of electronic signals from user devices as approved and unapproved live programming sessions are attended by users using those respective user devices, each of these sessions having an associated session type; and
enabling updating of the individual compliance records based on the received electronic signals and conditioned on verification information received in connection with the received electronic signals, the verification information purporting to verify participation in the respective sessions by the users of the respective user devices, wherein the verification information has a verification information type variable based on the session type associated with the respective session.

29. (canceled)

30. The method of claim 28, wherein verification types include at least two of:
a first verification information type that requires a selfie picture taken with a camera of a user device of a user seeking to verify participation in a corresponding session;
a second verification information type that requires a code input into a user device of a user seeking to verify participation in a corresponding session;
a third verification information type that is based on submission of a post-session follow-up survey submission;
a fourth verification information type that is a self-verification based on a user indication of participation; and
a fifth verification information type accompanying the second user input and purporting to verify participation in the unapproved live programming session by the party providing the received second user input.

31-39. (canceled)

40. The method of claim 28, wherein the first and/or second computer-mediated approval workflows are dynamically defined to facilitate communication among and/or between computing platforms operated by one or more of an administrative authority responsible for granting final approval, a space and/or facilities manager, and users initiating the respective workflows.

41. The method of claim 40, wherein the first and/or second computer-mediated approval workflows permit messages to be passed between users of the different computing platforms.

42. The method of claim 40, wherein the first and/or second computer-mediated approval workflows is/are defined to be unidirectional and to permit operations only by the party with whom responsibility currently lies.

43. The method of claim 28, further comprising generating a display including information about the sessions, wherein the information about the sessions includes a list of approved and unapproved live programming sessions, the list being searchable and/or filterable.

44-45. (canceled)

46. The method of claim 43, wherein the information about the sessions includes a session-by-session breakdown of: how many people participated in the respective session; a rating related to the respective session; a date and/or location of the respective session, a type, domain, requirement, objective, or other attribute, associated with the respective session; and/or which individual members participated in the respective session.

47-48. (canceled)

49. The method of claim 28, further comprising generating a display including information about the sessions attended by a given individual member,
wherein the information about the sessions includes a list of approved and unapproved live programming sessions attended by the given individual member, and
wherein the list is searchable and/or filterable based on session type, whether the session took place in the past or present, and/or whether follow-up action is required.

50-54. (canceled)

55. A non-transitory computer readable storage medium comprising instructions that, when executed, perform operations comprising:
having stored to a non-transitory data store individual compliance records, each individual compliance record including information indicating an extent to which a plurality of requirements having different respective requirement types have been satisfied by an individual member associated with the respective individual compliance record, the requirements being satisfiable in different ways by different individual members, a first requirement having a first requirement type requiring real-time participation in a plurality of approved live programming sessions, each approved live programming session being assigned to one of a plurality of predefined domains, different individual members being able to satisfy the first requirement by participating in different sets of the approved live programming sessions;
receiving first user input defining a proposed live programming session, the first user input being receivable in accordance with a first standardized user interface template facilitating specification of at least (a) one of the plurality of predefined domains applicable to the proposed live programming session being defined, (b) a location for the proposed live programming session being defined, and (c) one or more additional attributes of the proposed live programming session being defined;
responsive to receipt of first user input defining the proposed live programming session:
initiating a first computer-mediated approval workflow for the proposed live programming session, the first computer-mediated approval workflow being defined dynamically based on user credentials of the party providing the received first user input and content of the received first user input; and
designating the proposed live programming session as being one of the approved live programming sessions, conditioned on a successful outcome of the initiated first computer-mediated approval workflow;
receiving second user input for an unapproved live programming session, the second user input being receivable in accordance with a second standardized user interface template provided that the unapproved live programming session is of a first type and in accordance with a third standardized user interface template provided that the unapproved live programming session is of a second type, the first and second types being different from one another;
responsive to receipt of second user input for the unapproved live programming session:
initiating a second computer-mediated approval workflow for the unapproved live programming session, the second computer-mediated approval workflow being defined dynamically based whether the unapproved live programming session is of the first type or of the second type; and
designating the unapproved live programming session as being one of the approved live programming sessions, conditioned on a successful outcome of the initiated second computer-mediated approval workflow;
enabling receipt of electronic signals from user devices as approved and unapproved live programming sessions are attended by users using those respective user devices, each of these sessions having an associated session type; and
enabling updating of the individual compliance records based on the received electronic signals and conditioned on verification information received in connection with the received electronic signals, the verification information purporting to verify participation in the respective sessions by the users of the respective user devices, wherein the verification information has a verification information type variable based on the session type associated with the respective session.
